(19) United States
(12) Patent Application Publication
(10) Pub. No.: US 2025/0342676 A1
(43) Pub. Date: Nov. 6, 2025

(54) Soft-Body Object Rendering

(71) Applicant: Tencent Technology (Shenzhen) Company Limited, Shenzhen (CN)

(72) Inventor: Yao Li, Shenzhen (CN)

(21) Appl. No.: 19/271,872

(22) Filed: Jul. 17, 2025

Related U.S. Application Data
(63) Continuation of application No. PCT/CN2024/092643, filed on May 11, 2024.

(30) Foreign Application Priority Data
Jul. 4, 2023 (CN) 2023108101601

(51) Int. Cl. G06T 19/20; G06T 17/20

(52) U.S. Cl. CPC G06T 19/20; G06T 17/20; G06T 2210/12; G06T 2210/16; G06T 2219/2016; G06T 2219/2021

(57) ABSTRACT

Soft-body object rendering techniques are described herein. The techniques may include obtaining a first physical mesh model and a first graphic mesh model of a soft-body object in a preset first form, precision of the first physical mesh model being less than precision of the first graphic mesh model; identifying a rendering vertex in a first-type mesh region of the first graphic mesh model as a first rendering vertex, determining a mapping face corresponding to the first rendering vertex from faces of the first physical mesh model, and determining relative location information between the first rendering vertex and the mapping face; identifying a rendering vertex in a second-type mesh region of the first graphic mesh model as a second rendering vertex, determining a mapping physical vertex corresponding to the second rendering vertex from physical vertexes in the first physical mesh model, and determining relative location information between the second rendering vertex and the corresponding mapping physical vertex, complexity of the second-type mesh region being higher than complexity of the first-type mesh region; generating, based on each piece of relative location information, model mapping information corresponding to the soft-body object; and transforming, when rendering the soft-body object, the first graphic mesh model based on the model mapping information and transformation of the first physical mesh model, and rendering the soft-body object by using a transformed first graphic mesh model.

### CROSS-REFERENCE TO RELATED APPLICATIONS

This application is a Continuation application of PCT Application PCT/CN2024/092642, filed May 11, 2024, which claims priority to Chinese Patent Application No. 2023108101601, filed Jul. 4, 2023, each entitled “SOFT-BODY OBJECT RENDERING METHOD AND APPARATUS, COMPUTER DEVICE, AND STORAGE MEDIUM” and each of which is incorporated herein by reference in its entirety.

### FIELD

This application relates to the field of computer technologies, and in particular, to a soft-body object rendering method and apparatus, a computer device, and a storage medium.

### BACKGROUND

With the development of computer technologies, a virtual scene is used more and more widely. There is usually a soft-body object in the virtual scene. The soft-body object is, for example, clothes on a character in the virtual scene, or may be a curtain, a handkerchief, or the like in the virtual scene. Because a status of the soft-body object changes under an action of an external force, the action of the external force on the soft-body object needs to be considered in a real-time rendering process in the virtual scene, so that a rendered soft-body object is more realistic.

In a conventional technology, a first physical mesh model and a first graphic mesh model are generated for the soft-body object, and a mapping relationship is established between the first physical mesh model and the first graphic mesh model. When the external force is applied to the soft-body object, a form of the first physical mesh model is adjusted based on the external force, and a form of the first graphic mesh model is adjusted based on the mapping relationship between the first physical mesh model and the first graphic mesh model. Then, the first graphic mesh model is rendered to obtain a soft-body object formed under the action of the external force.

However, for a complex soft-body object such as multilayer clothes, rendering effects of the conventional technology are poor, and there is a rendering distortion.

### SUMMARY

According to aspects described herein, a soft-body object rendering method and apparatus, a computer device, a computer-readable storage medium, and a computer program product are provided.

According to an aspect, this application provides a soft-body object rendering method, performed by a computer device. The method includes:
obtaining a first physical mesh model and a first graphic mesh model of a soft-body object in a preset first form, precision of the first physical mesh model being less than precision of the first graphic mesh model;
using a rendering vertex in a first-type mesh region of the first graphic mesh model as a first rendering vertex, determining a mapping face corresponding to the first rendering vertex from faces of the first physical mesh model, and determining relative location information between the first rendering vertex and the mapping face;
using a rendering vertex in a second-type mesh region of the first graphic mesh model as a second rendering vertex, determining a mapping physical vertex corresponding to the second rendering vertex from physical vertexes in the first physical mesh model, and determining relative location information between the second rendering vertex and the corresponding mapping physical vertex, complexity of the second-type mesh region being higher than complexity of the first-type mesh region;
generating, based on each piece of relative location information, model mapping information corresponding to the soft-body object; and
transforming, when rendering the soft-body object, the first graphic mesh model based on the model mapping information and transformation of the first physical mesh model, and rendering the soft-body object by using a transformed first graphic mesh model.

According to another aspect, this application further provides a soft-body object rendering apparatus. The apparatus includes:
a mesh model obtaining module, configured to obtain a first physical mesh model and a first graphic mesh model of a soft-body object in a preset first form, precision of the first physical mesh model being less than precision of the first graphic mesh model;
a first information determining module, configured to: use a rendering vertex in a first-type mesh region of the first graphic mesh model as a first rendering vertex, determine a mapping face corresponding to the first rendering vertex from faces of the first physical mesh model, and determine relative location information between the first rendering vertex and the mapping face;
a second information determining module, configured to: use a rendering vertex in a second-type mesh region of the first graphic mesh model as a second rendering vertex, determine a mapping physical vertex corresponding to the second rendering vertex from physical vertexes in the first physical mesh model, and determine relative location information between the second rendering vertex and the corresponding mapping physical vertex, complexity of the second-type mesh region being higher than complexity of the first-type mesh region;
a mapping information determining module, configured to generate, based on each piece of relative location information, model mapping information corresponding to the soft-body object; and
a rendering module, configured to: transform, when rendering the soft-body object, the first graphic mesh model based on the model mapping information and transformation of the first physical mesh model, and render the soft-body object by using a transformed first graphic mesh model.

According to another aspect, this application further provides a computer device. The computer device includes a memory and a processor. The memory has a computer program stored therein. The processor, when executing the computer program, implements the operations of the foregoing soft-body object rendering method.

According to another aspect, this application further provides a computer-readable storage medium. The computer-readable storage medium has a computer program stored therein. The computer program, when executed by a processor, causes the operations of the foregoing soft-body object rendering method to be implemented.

According to another aspect, this application further provides a computer program product. The computer program product includes a computer program. The computer program, when executed by a processor, causes the operations of the foregoing soft-body object rendering method to be implemented.

Details of one or more aspects described herein are provided in the accompanying drawings and descriptions below. Other features, objectives, and advantages described herein become apparent from the specification, the drawings, and the claims.

### BRIEF DESCRIPTION OF THE DRAWINGS

To describe the technical solutions in aspects described herein or the conventional technology more clearly, the following briefly describes the accompanying drawings required for describing the aspects or the conventional technology. Apparently, the accompanying drawings in the following descriptions show merely aspects described herein, and a person of ordinary skill in the art may still derive other accompanying drawings from the disclosed accompanying drawings without creative efforts.

FIG. 1 is a diagram of an application environment of a soft-body object rendering method according to some aspects.

FIG. 2 is a schematic flowchart of a soft-body object rendering method according to one or more illustrative aspects described herein.

FIG. 3 is a principle diagram of obtaining a graphic mesh model formed under an action of an external force according to one or more illustrative aspects described herein.

FIG. 4 is a schematic diagram of a graphic mesh model formed under an action of an external force according to one or more illustrative aspects described herein.

FIG. 5 is a schematic flowchart of a soft-body object rendering method according to one or more illustrative aspects described herein.

FIG. 6 is a schematic diagram of setting a weight for a physical mesh model according to one or more illustrative aspects described herein.

FIG. 7 is a schematic diagram of setting a weight for a graphic mesh model according to one or more illustrative aspects described herein.

FIG. 8 is a schematic diagram of obtaining model mapping information according to one or more illustrative aspects described herein.

FIG. 9 is a schematic flowchart of a soft-body object rendering method according to one or more illustrative aspects described herein.

FIG. 10 is a block diagram of a structure of a soft-body object rendering apparatus according to one or more illustrative aspects described herein.

FIG. 11 is a diagram of an internal structure of a computer device according to one or more illustrative aspects described herein.

FIG. 12 is a diagram of an internal structure of a computer device according to one or more illustrative aspects described herein.

### DETAILED DESCRIPTION

The technical solutions in aspects described herein are clearly and completely described in the following with reference to the accompanying drawings in the aspects described herein. The described aspects are merely some rather than all of the aspects described herein. All other aspects obtained by a person of ordinary skill in the art based on the aspects described herein without creative efforts shall fall within the protection scope described herein.

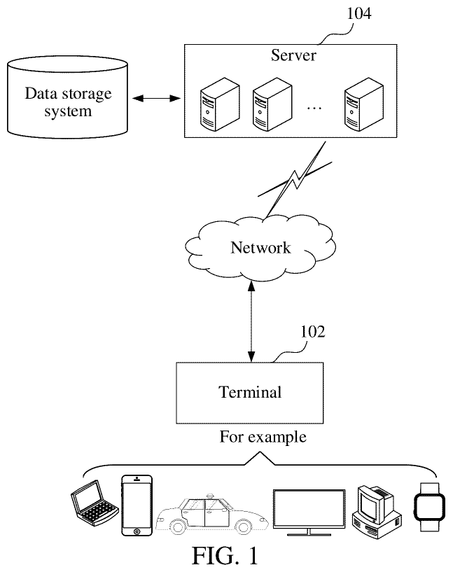

A soft-body object rendering method provided in the aspects described herein may be applied to an application environment shown in FIG. 1. A terminal 102 communicates with a server 104 through a network. A data storage system may store data that the server 104 needs to process. The data storage system may be integrated on the server 104, or may be placed on a cloud or another server.

Specifically, the terminal 102 obtains a first physical mesh model and a first graphic mesh model of a soft-body object in a preset first form, precision of the first physical mesh model being less than precision of the first graphic mesh model. The terminal 102 uses a rendering vertex in a first-type mesh region of the first graphic mesh model as a first rendering vertex, determines a mapping face corresponding to the first rendering vertex from faces of the first physical mesh model, and determines relative location information between the first rendering vertex and the mapping face. The terminal 102 uses a rendering vertex in a second-type mesh region of the first graphic mesh model as a second rendering vertex, determines a mapping physical vertex corresponding to the second rendering vertex from physical vertexes in the first physical mesh model, and determines relative location information between the second rendering vertex and the corresponding mapping physical vertex, complexity of the second-type mesh region being higher than complexity of the first-type mesh region. The terminal 102 generates, based on each piece of relative location information, model mapping information corresponding to the soft-body object. The terminal 102 may transmit the model mapping information corresponding to the soft-body object to the server 104. The server 104 may store the model mapping information corresponding to the soft-body object. When another device renders an image including the soft-body object, the server 104 may transmit the model mapping information corresponding to the soft-body object to the another device, so that when rendering the soft-body object, the another device transforms the first graphic mesh model based on the model mapping information and transformation of the first physical mesh model, and renders the soft-body object by using a transformed first graphic mesh model.

The terminal 102 may be but is not limited to various desktop computers, notebook computers, smartphones, tablet computers, Internet of things devices, and portable wearable devices. The Internet of things device may be a smart speaker, a smart television, a smart air conditioner, a smart in-vehicle device, or the like. The portable wearable device may be a smartwatch, a smart band, a head-mounted device, or the like. The server 104 may be implemented by using an independent server or a server cluster including a plurality of servers.

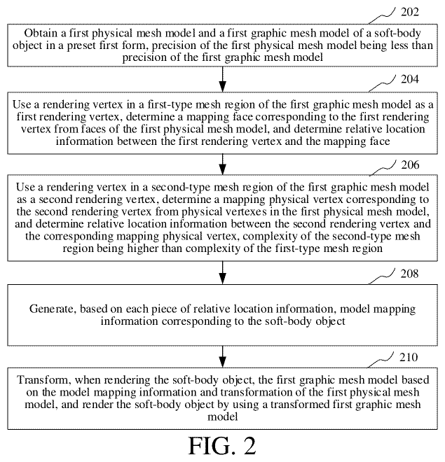

In some aspects, as shown in FIG. 2, a soft-body object rendering method is provided. The method may be performed by a terminal or a server, or may be performed jointly by a terminal and a server. An application of the method to the terminal in FIG. 1 is used as an example for description. The method includes the following operations.

Operation 202: Obtain a first physical mesh model and a first graphic mesh model of a soft-body object in a preset first form, precision of the first physical mesh model being less than precision of the first graphic mesh model.

The soft-body object is a flexible object. The soft-body object has the following characteristics: When a non-destructive external force is applied to the soft-body object, the soft-body object deforms, and when the external force is removed, the soft-body object does not return to an original shape. The soft-body object is an object in a virtual scene. The soft-body object may be an object made of a flexible material. The flexible material includes but is not limited to cloth, rubber, or the like. The soft-body object includes but is not limited to at least one of clothes of a character in the virtual scene, a curtain or a handkerchief in the virtual scene, a ball in the virtual scene, and the like. The clothes of the character in the virtual scene may be single-layer clothes or multilayer clothes. The multilayer clothes are clothes including at least two layers of cloth.

The virtual scene is a virtual scene displayed (or provided) when an application is run on the terminal. The virtual scene may be a simulated environmental scene for a real world, may be a semi-simulated semi-fictional three-dimensional environmental scene, or may be an entirely fictional three-dimensional environmental scene. The virtual scene may be any one of a two-dimensional virtual scene, a 2.5-dimensional virtual scene, and a three-dimensional virtual scene. A target observation perspective may be any observation perspective. The virtual scene includes but is not limited to scenes such as a movie and television special effect, a game, visual simulation, a visual design, virtual reality (VR), and digital cultural innovation.

A physical mesh model and a graphic mesh model are both three-dimensional mesh models. The three-dimensional mesh model includes vertexes, edges, and faces. The three-dimensional mesh model may include a plurality of vertexes, an edge is a line connecting two vertexes, and a face is a triangle formed by connecting three vertexes. A smallest geometrical figure of the three-dimensional mesh model is a triangle, and the triangle includes three vertexes and three edges. The first physical mesh model and the first graphic mesh model are both configured for representing the soft-body object, and are different in precision. The precision of the first physical mesh model is less than the precision of the first graphic mesh model. Therefore, the physical mesh model may also be referred to as a low model, and the first graphic mesh model may also be referred to as a high model. The precision may be determined based on a quantity of vertexes, and a larger quantity of vertexes indicates higher precision. A quantity of vertexes included in the first physical mesh model is less than a quantity of vertexes included in the first graphic mesh model. For example, the quantity of vertexes included in the first physical mesh model is 10660, and the quantity of vertexes included in the first graphic mesh model is 12748. Alternatively, the precision may be determined based on a quantity of faces, and a larger quantity of faces indicates higher precision. A quantity of faces included in the first physical mesh model is less than a quantity of faces included in the first graphic mesh model.

When the soft-body object includes a plurality of connected or independent components, both the first physical mesh model and the first graphic mesh model may have a multilayer structure. The multilayer structure is a structure formed by connecting at least two deformable surfaces together in any relative direction. Such a structure can be used to model complex objects such as a clothes accessory and multilayer clothes. Different surfaces may be connected together to form a surface including a plurality of layers, each of which has a unique geometrical form and motion mode.

The deformable surface is a surface whose geographical form may be changed to simulate a motion and deformation of an object. The deformable surface is usually formed by a plurality of triangles, and a quantity of triangles may be increased or decreased as required. In the field of computer graphics, the deformable surface is widely used in modeling of various complex objects, such as clothes, skin, and liquid. The deformable surface may be finely controlled to achieve physical simulation effects and provide a powerful tool support for the fields of virtual reality, game development, and the like.

A form of the soft-body object is changeable. For example, the soft-body object is the multilayer clothes of the character, and a form of the multilayer clothes is changeable. The preset form may be any form of the soft-body object. The vertex in the physical mesh model of the soft-body object is movable. Therefore, a location of the vertex in the physical mesh model of the soft-body object is changed, so that the physical mesh model represents the soft-body object in any form. Similarly, the vertex in the graphic mesh model of the soft-body object is also movable. A location of the vertex in the graphic mesh model of the soft-body object is changed, so that the graphic mesh model represents the soft-body object in a different form.

The first physical mesh model of the soft-body object in the preset first form is configured for representing the soft-body object in the preset first form, that is, is configured for representing the soft-body object having the preset first form. The first graphic mesh model of the soft-body object in the preset first form is configured for representing the soft-body object in the preset first form, that is, is configured for representing the soft-body object having the preset first form. For ease of distinguishing between physical mesh models of the soft-body object in different forms, a physical mesh model of the soft-body object in the preset first form is referred to as the first physical mesh model, and a graphic mesh model of the soft-body object in the preset first form is referred to as the first graphic mesh model. The physical mesh models of the soft-body object in different forms are of a same model structure, that is, include same vertexes, same edges, and same faces, and a difference lies only in locations of the vertexes. Changes in the locations of the vertexes cause changes in locations of the edges and locations of the faces. Similarly, graphic mesh models of the soft-body object in different forms are also of a same model structure, and only locations of vertexes, edges, and faces are different.

Specifically, the first physical mesh model of the soft-body object in the preset first form is generated in advance. The first graphic mesh model of the soft-body object in the preset first form is generated in advance. For example, it may be generated by using a tool for generating a three-dimensional mesh model.

In some aspects, the first physical mesh model and the first graphic mesh model may be stored by using a same Filmbox (FBX) file. Filmbox (FBX) is a three-dimensional (3D) file format, and is mainly used for performing model and scene interaction between different 3D software. The FBX file may be used in the fields of game development, virtual reality, film production, industrial design, and the like. In other words, the first physical mesh model and the first graphic mesh model may be stored in the FBX file. Certainly, the first physical mesh model and the first graphic mesh model may alternatively be stored by using different FBX files.

Operation 204: Use a rendering vertex in a first-type mesh region of the first graphic mesh model as a first rendering vertex, determine a mapping face corresponding to the first rendering vertex from faces of the first physical mesh model, and determine relative location information between the first rendering vertex and the mapping face.

The vertex in the graphic mesh model may be referred to as a rendering vertex, and the vertex in the physical mesh model may be referred to as a physical vertex. A mesh region is a part of a three-dimensional mesh model, and the three-dimensional mesh model may be a physical mesh model or a graphic mesh model. A mesh region of the first graphic mesh model may be classified as a first-type mesh region or a second-type mesh region, and complexity of the second-type mesh region is higher than complexity of the first-type mesh region. The complexity may be determined based on a density of vertexes. For example, a higher density of vertexes indicates higher complexity. The first graphic mesh model may include at least one second-type mesh region. The first graphic mesh model may include at least one first-type mesh region. Complexity of each second-type mesh region is higher than complexity of each first-type mesh region. Alternatively, the complexity may be distinguished based on whether there is a wrinkle or whether there is concavity. Complexity of an unwrinkled mesh region is lower than complexity of a wrinkled or concave mesh region. For example, the soft-body object is the multilayer clothes. The first graphic mesh model represents the multilayer clothes, and mesh regions at a ribbon, a decoration, and a skirt hemline with low flatness on the multilayer clothes are first-type mesh regions.

The mesh region includes a plurality of vertexes, and “a plurality of” means “at least two”. The first rendering vertex is a rendering vertex in the first-type mesh region of the first graphic mesh model.

Specifically, the terminal may generate corresponding bounding boxes for the faces of the first physical mesh model, the bounding boxes corresponding to the faces being geometrical bodies enclosing the faces. The terminal may determine, from the generated bounding boxes, a bounding box in which the first rendering vertex is located, to obtain an adjacent bounding box corresponding to the first rendering vertex. The terminal may determine a face corresponding to the adjacent bounding box as an adjacent face of the first rendering vertex, and determine, from the adjacent face of the first rendering vertex, the mapping face corresponding to the first rendering vertex.

In some aspects, the terminal may determine any adjacent face in each adjacent face of the first rendering vertex as the mapping face corresponding to the first rendering vertex. Alternatively, the terminal may project the first rendering vertex to a plane on which the adjacent face is located, and if a projection point of the first rendering vertex on the plane on which the adjacent face is located is on the adjacent face, determine the adjacent face as the mapping face corresponding to the first rendering vertex.

In some aspects, the terminal may project the first rendering vertex to the mapping face, and determine a projection point of the first rendering vertex on the mapping face. The terminal may determine first relative location information between the projection point and the mapping face, and determine second relative location information between the projection point and the first rendering vertex. A location of the projection point is correlated with a location of the mapping face by using the first relative location information, and a location of the first rendering vertex is correlated with the location of the projection point by using the second relative location information. The terminal may obtain the relative location information between the first rendering vertex and the mapping face based on the first relative location information and the second relative location information.

Operation 206: Use a rendering vertex in a second-type mesh region of the first graphic mesh model as a second rendering vertex, determine a mapping physical vertex corresponding to the second rendering vertex from physical vertexes in the first physical mesh model, and determine relative location information between the second rendering vertex and the corresponding mapping physical vertex, complexity of the second-type mesh region being higher than complexity of the first-type mesh region.

The second rendering vertex is a rendering vertex in the second-type mesh region of the first graphic mesh model. The complexity of the second-type mesh region is higher than the complexity of the first-type mesh region. The mapping physical vertex corresponding to the second rendering vertex may be referred to as a mapping point corresponding to the second rendering vertex.

Specifically, the terminal may generate the corresponding bounding boxes for the faces of the first physical mesh model, determine, from the bounding boxes of the faces, a bounding box in which the second rendering vertex is located, to obtain a target bounding box, and determine a face corresponding to the target bounding box as a target face corresponding to the second rendering vertex. There may be one target face or a plurality of target faces, and “a plurality of” means “at least two”. The terminal may determine distances between physical vertexes on each target face and the second rendering vertex, and determine, based on the distances between the physical vertexes on each target face and the second rendering vertex, the mapping physical vertex corresponding to the second rendering vertex from the physical vertexes on each target face.

In some aspects, for each physical vertex on each target face, the terminal calculates the distance between the physical vertex and the second rendering vertex. The terminal determines a physical vertex with a minimum distance as the mapping physical vertex corresponding to the second rendering vertex.

In some aspects, the relative location information between the second rendering vertex and the corresponding mapping physical vertex is configured for establishing a relationship between coordinates of the mapping physical vertex and coordinates of the second rendering vertex. For example, the relative location information may be an affine transformation matrix, and the affine transformation matrix is configured for establishing the relationship between the coordinates of the mapping physical vertex and the coordinates of the second rendering vertex. A result obtained by transforming the mapping physical vertex by using the affine transformation matrix is the coordinates of the second rendering vertex. For example, if the affine transformation matrix is M, the coordinates of the mapping physical vertex are P1, and the coordinates of the second rendering vertex are P2, P2=P1*M.

Operation 208: Generate, based on each piece of relative location information, model mapping information corresponding to the soft-body object.

Specifically, the terminal combines the relative location information between the first rendering vertex and the corresponding mapping face and the relative location information between the second rendering vertex and the mapping physical vertex, to form the model mapping information corresponding to the soft-body object.

Operation 210: Transform, when rendering the soft-body object, the first graphic mesh model based on the model mapping information and transformation of the first physical mesh model, and render the soft-body object by using a transformed first graphic mesh model.

In some aspects, operation 202 to operation 208 are performed offline, that is, are operations performed in advance before real-time rendering. In other words, the model mapping information is generated in advance rather than during real-time rendering. Operation 210 is performed during real-time rendering. Real-time rendering may be performed based on the model mapping information generated in advance, to obtain a rendering result of the soft-body object.

In some aspects, in a real-time rendering process of the soft-body object, the terminal obtains a second physical mesh model of the soft-body object in a current state and a second graphic mesh model of the soft-body object in the current state. The terminal moves a physical vertex subjected to an action of an external force in the second physical mesh model, to obtain a first physical mesh model formed under the action of the external force; determines, for a first rendering vertex subjected to the action of the external force in the second graphic mesh model, relative location information between the first rendering vertex and a corresponding mapping face from the model mapping information; moves, based on the relative location information between the first rendering vertex and the corresponding mapping face, the first rendering vertex subjected to the action of the external force; determines, for a second rendering vertex subjected to the action of the external force in the second graphic mesh model, relative location information between the second rendering vertex and a corresponding mapping physical vertex from the model mapping information; moves, based on the relative location information between the second rendering vertex and the corresponding mapping physical vertex, the second rendering vertex subjected to the action of the external force, to obtain a first graphic mesh model formed under the action of the external force; and renders the first graphic mesh model formed under the action of the external force, to obtain the rendering result of the soft-body object. The external force is a force applied by an object other than the soft-body object to the soft-body object. For example, in the virtual scene, the external force may be a force generated by an object in contact with the soft-body object in the virtual scene. For example, the soft-body object is the multilayer clothes, and the character wearing the multilayer clothes may apply a force to the multilayer clothes to deform the multilayer clothes during a movement. Certainly, the external force may alternatively be a force generated by wind in the virtual scene.

In the soft-body object rendering method, the first physical mesh model and the first graphic mesh model of the soft-body object in the preset first form are obtained. The precision of the first physical mesh model is less than the precision of the first graphic mesh model. The mapping face corresponding to the first rendering vertex is determined from the faces of the first physical mesh model, and the relative location information between the first rendering vertex and the mapping face is determined. The first rendering vertex is a rendering vertex in the first-type mesh region of the first graphic mesh model. The mapping physical vertex corresponding to the second rendering vertex is determined from the physical vertexes in the first physical mesh model, and the relative location information between the second rendering vertex and the corresponding mapping physical vertex is determined. The second rendering vertex is a rendering vertex in the second-type mesh region of the first graphic mesh model. The complexity of the second-type mesh region is higher than the complexity of the first-type mesh region. The model mapping information corresponding to the soft-body object is generated based on each piece of relative location information. The model mapping information is configured for transforming the first graphic mesh model based on transformation of the first physical mesh model during rendering. The transformed first graphic mesh model is configured for rendering the soft-body object. Therefore, a vertex-vertex relationship is established for a high-complexity mesh region, and a vertex-face relationship is established for a low-complexity mesh region. This makes the model mapping information more appropriate. Therefore, using the model mapping information to transform the first graphic mesh model based on transformation of the first physical mesh model during rendering can improve effects of the transformed first graphic mesh model, and rendering the transformed first graphic mesh model can improve rendering effects and reduce distortion.

The soft-body object rendering method provided described herein may be applied to generation of corresponding model mapping information for any soft-body object. The model mapping information may be understood as a mapping relationship established between a physical mesh model and a graphic mesh model. A conventional method for establishing a mapping relationship between a physical mesh model and a graphic mesh model does not allow an excessively large difference between the physical mesh model and the graphic mesh model, limiting flexibility and diversity of making a soft-body object. The soft-body object rendering method provided described herein allows an excessively large difference between the first physical mesh model and the first graphic mesh model, so that a more flexible modeling manner is implemented, improving the flexibility and the diversity of making a soft-body object.

In the conventional method for establishing a mapping relationship between a physical mesh model and a graphic mesh model, a discontinuous topology of the physical mesh model may cause a mapping exception; and if the graphic mesh model is not so flat with concavity, or the graphic mesh model has a multilayer structure, the established mapping relationship causes severe intersection of the graphic mesh model during application, resulting in poor effects. In the soft-body object rendering method provided described herein, there is no limitation of topological continuity, and complementarity between two algorithms (that is, establishment of a point-face relationship and establishment of a point-point relationship) breaks limitations of a non-concave mesh and non-multilayer cloth, and improves mapping effects and stability.

For a high-precision graphic mesh model, for example, in a high-precision cloth simulation scenario, a mapping relationship established by using the conventional method for establishing a mapping relationship between a physical mesh model and a graphic mesh model cannot meet a requirement. The soft-body object rendering method provided described herein can be well applied to the high-precision cloth simulation scenario due to the complementarity between the two algorithms (that is, establishment of the point-face relationship and establishment of the point-point relationship).

In some aspects, the determining relative location information between the first rendering vertex and the mapping face includes: projecting the first rendering vertex to the mapping face, and determining the projection point of the first rendering vertex on the mapping face; determining the first relative location information between the projection point and the mapping face, and determining the second relative location information between the projection point and the first rendering vertex; and obtaining the relative location information between the first rendering vertex and the mapping face based on the first relative location information and the second relative location information.

The location of the projection point is correlated with the location of the mapping face by using the first relative location information. The location of the first rendering vertex is correlated with the location of the projection point by using the second relative location information. The first relative location information is configured for establishing a relationship between coordinates of the projection point and coordinates of each physical vertex on the mapping face. For example, a result of performing linear transformation on the coordinates of each physical vertex on the mapping face by using the first relative location information is the coordinates of the projection point. The coordinates of the projection point may be represented as a linear relationship between the first relative location information and the coordinates of each physical vertex on the mapping face.

Specifically, the second relative location information between the projection point and the first rendering vertex may be a normal offset. The normal offset is a movement distance required for moving the projection point to the first rendering vertex in a normal direction of a mapping plane.

In some aspects, the terminal may use the first relative location information and the second relative location information as the relative location information between the first rendering vertex and the corresponding mapping face. In other words, the relative location information between the first rendering vertex and the corresponding mapping face includes the first relative location information and the second relative location information.

In this aspect, the location of the projection point is correlated with the location of the mapping face by using the first relative location information, and the location of the first rendering vertex is correlated with the location of the projection point by using the second relative location information. Therefore, when the location of the mapping face changes, the first rendering vertex may be correspondingly moved by using the first relative location information and the second relative location information.

In some aspects, the determining the first relative location information between the projection point and the mapping face includes: determining the first relative location information between the projection point and the mapping face by using the coordinates of each physical vertex on the mapping face and the coordinates of the projection point, the first relative location information between the projection point and the mapping face being configured for establishing a linear relationship between the coordinates of each physical vertex on the mapping face and the coordinates of the projection point.

Specifically, the first relative location information includes a first coefficient and a second coefficient. A third coefficient may be obtained by using the first coefficient and the second coefficient. The third coefficient=1−the first coefficient−the second coefficient. The linear relationship between the coordinates of the projection point and the coordinates of each physical vertex on the mapping face may be represented as P1−a1*A1+a2*B1+ (1−a1−a2)*C1, where a1 is the first coefficient, a2 is the second coefficient, 1−a1−a2 is the third coefficient, A1 is coordinates of the 1^{st} vertex on the mapping face, B1 is coordinates of the 2^{nd} vertex on the mapping face, C1 is coordinates of the 3^{rd} vertex on the mapping face, and P1 is the coordinates of the projection point. The first relative location information may be (the first coefficient, the second coefficient, 1−the first coefficient−the second coefficient), and (the first coefficient, the second coefficient, 1−the first coefficient−the second coefficient) may be referred to as barycentric coordinates of the projection point on the mapping face. The first coefficient, the second coefficient, and the third coefficient are all values ranging from 0 to 1.

In this aspect, because the first relative location information between the projection point and the mapping face is configured for establishing the linear relationship between the coordinates of each physical vertex on the mapping face and the coordinates of the projection point, a linear relationship in location between the projection point and the mapping face is established by using the linear relationship. Because complexity of linear calculation is low, calculation efficiency is improved.

In some aspects, the transforming the first graphic mesh model based on the model mapping information and transformation of the first physical mesh model, and rendering the soft-body object by using a transformed first graphic mesh model includes: obtaining a second physical mesh model representing the soft-body object in a second form, and moving a physical vertex subjected to an action of an external force in the second physical mesh model, to obtain a first physical mesh model formed under the action of the external force; obtaining a second graphic mesh model representing the soft-body object in the second form, and determining, for a first rendering vertex subjected to the action of the external force in the second graphic mesh model, relative location information between the first rendering vertex and a corresponding mapping face from the model mapping information; moving, based on the relative location information between the first rendering vertex and the corresponding mapping face, the first rendering vertex subjected to the action of the external force, to obtain a first graphic mesh model formed under the action of the external force; and rendering the soft-body object by using the first graphic mesh model formed under the action of the external force.

Physical mesh models of the soft-body object in different forms are of a same model structure, that is, include same vertexes, same edges, and same faces, but locations of the vertexes are different. Changes in the locations of the vertexes cause changes in locations of the edges and locations of the faces. Similarly, graphic mesh models of the soft-body object in different forms are also of a same model structure, and only locations of vertexes, edges, and faces are different. A model structure of the first physical mesh model is consistent with a model structure of the second physical mesh model, and a model structure of the first graphic mesh model is consistent with a model structure of the second graphic mesh model. For example, if a quantity of vertexes in the first physical mesh model is 1000, a quantity of vertexes in the second physical mesh model is also 1000, a connection relationship between the 1000 vertexes in the first physical mesh model is consistent with a connection relationship between the 1000 vertexes in the second physical mesh model, and a difference lies in that locations (that is, coordinates) of some or all of the vertexes are inconsistent. For another example, if a quantity of vertexes in the first graphic mesh model is 3000, a quantity of vertexes in the second graphic mesh model is also 3000, a connection relationship between the 3000 vertexes in the first graphic mesh model is consistent with a connection relationship between the 3000 vertexes in the second graphic mesh model, and a difference lies in that locations (that is, coordinates) of some or all of the vertexes are inconsistent.

The external force is a force applied by an object other than the soft-body object to the soft-body object. For example, in the virtual scene, the external force may be a force generated by an object in contact with the soft-body object in the virtual scene. For example, the soft-body object is the multilayer clothes, and the character wearing the multilayer clothes may apply a force to the multilayer clothes to deform the multilayer clothes during a movement. Certainly, the external force may alternatively be a force applied by wind to the object in the virtual scene.

The model mapping information includes the relative location information between the first rendering vertex and the corresponding mapping face, and further includes the relative location information between the second rendering vertex and the corresponding mapping physical vertex.

Specifically, the terminal may perform physical simulation on the second physical mesh model, to move a physical vertex subjected to the action of the external force in the second physical mesh model, to obtain the first physical mesh model formed under the action of the external force. All or some physical vertexes in the second physical mesh model are subjected to the action of the external force. Physical simulation is used for determining a location change of the physical vertex under the action of the external force, to move the physical vertex based on the location change, to obtain the first physical mesh model formed under the action of the external force.

In some aspects, the terminal may determine coordinates of each physical vertex on the mapping face from the second physical mesh model, and perform linear transformation on the coordinates of each physical vertex on the mapping face by using the first relative location information, to obtain coordinates of the projection point of the first rendering vertex on the mapping face in the second physical mesh model. Because a location of the mapping face in the first physical mesh model may be different from a location of the mapping face in the second physical mesh model, the coordinates of the projection point in the second physical mesh model may be different from the coordinates of the projection point in the first physical mesh model. Specifically, the terminal may calculate the coordinates of the projection point of the first rendering vertex on the mapping face in the second physical mesh model by using a formula P2=a1*A2+a2*B2+ (1−a1-a2)*C2, where P2 is the coordinates of the projection point of the first rendering vertex on the mapping face in the second physical mesh model, a1 and a2 are the first relative location information, A2 is coordinates of the 1^{st} vertex on the mapping face in the second physical mesh model, B2 is coordinates of the 2^{nd} vertex on the mapping face in the second physical mesh model, and C2 is coordinates of the 3^{rd} vertex on the mapping face in the second physical mesh model.

In some aspects, the terminal obtains, based on the coordinates of the projection point in the second physical mesh model and the second relative location information, a predicted location of the first rendering vertex subjected to the action of the external force, and moves the first rendering vertex subjected to the action of the external force in the second graphic mesh model to the predicted location, to obtain the first graphic mesh model formed under the action of the external force. Therefore, the action of the external force is indirectly applied to the second graphic mesh model, and the first graphic mesh model formed under the action of the external force presents an effect achieved under the action of the external force. Specifically, the second relative location information may be a normal offset. The normal offset is a movement distance required for moving the projection point to the first rendering vertex in a normal direction of the mapping plane. The terminal determines a location whose distance from the projection point in the normal direction of the mapping plane is equal to the normal offset, and uses the location as the predicted location of the first rendering vertex.

In some aspects, the terminal may determine a part of the soft-body object subjected to the action of the external force, to obtain an external-force affected part, and determine each physical vertex for representing the external-force affected part in the second physical mesh model as a physical vertex subjected to the action of the external force. The terminal may determine the part of the soft-body object subjected to the action of the external force, to obtain the external-force affected part, and determine each first rendering vertex for representing the external-force affected part in the second graphic mesh model as a first rendering vertex subjected to the action of the external force.

In this aspect, because the precision of the first physical mesh model is lower than the precision of the first graphic mesh model, a quantity of vertexes subjected to the action of the external force in the first physical mesh model is less than a quantity of vertexes subjected to the action of the external force in the first graphic mesh model. For example, a part of the soft-body object is subjected to the action of the external force, a quantity of vertexes representing the part in the first physical mesh model is 10, and a quantity of vertexes representing the part in the first graphic mesh model is 100. Because complexity of moving a vertex based on the external force is high, a vertex in the second physical mesh model is first moved based on the external force, and then a vertex in the second graphic mesh model is moved based on relative location information. Therefore, calculation complexity is reduced, and calculation efficiency is improved.

In some aspects, the determining a mapping face corresponding to the first rendering vertex from faces of the first physical mesh model includes: determining an adjacent face of the first rendering vertex from the faces of the first physical mesh model, the first rendering vertex being located in a bounding box of the adjacent face; and determining, based on the adjacent face of the first rendering vertex, the mapping face corresponding to the first rendering vertex.

The bounding box of the adjacent face is a geometrical body enclosing the adjacent face. The bounding box may be a geometrical body of any shape, including, but not limited to, a cube or a cuboid.

Specifically, the terminal may generate the bounding boxes for the faces of the first physical mesh model, determine, from the generated bounding boxes, the bounding box in which the first rendering vertex is located, to obtain the adjacent bounding box of the first rendering vertex, and determine the face corresponding to the adjacent bounding box as the adjacent face of the first rendering vertex.

In some aspects, when there is one adjacent face of the first rendering vertex, the terminal may determine the adjacent face as the mapping face corresponding to the first rendering vertex. When there are a plurality of adjacent faces of the first rendering vertex, the terminal may determine any one of the adjacent faces as the mapping face corresponding to the first rendering vertex.

In this aspect, the first rendering vertex is located in the bounding box of the adjacent face, so that the mapping face is adjacent to the first rendering vertex. Therefore, the mapping face is more appropriate.

In some aspects, the determining, based on the adjacent faces of the first rendering vertex, the mapping face corresponding to the first rendering vertex includes: projecting, for each adjacent face, the first rendering vertex to a plane on which the adjacent face is located, to obtain a projection point of the first rendering vertex on the plane on which the adjacent face is located; and determining the mapping face corresponding to the first rendering vertex from each adjacent face, a projection point of the first rendering vertex on a plane on which the mapping face is located being located on the mapping face.

Specifically, for each adjacent face, if the projection point of the first rendering vertex on the plane on which the adjacent face is located is located on the adjacent face, the adjacent face is determined as a candidate adjacent face.

In some aspects, if there is only one candidate adjacent face, the candidate adjacent face is determined as the mapping face corresponding to the first rendering vertex. If there are a plurality of candidate adjacent faces, any candidate adjacent face is determined as the mapping face corresponding to the first rendering vertex.

In this aspect, because the projection point of the first rendering vertex on the plane on which the mapping face is located is located on the mapping face, the mapping face is more appropriate.

In some aspects, the determining an adjacent face of the first rendering vertex from the faces of the first physical mesh model includes: generating the corresponding bounding boxes for the faces of the first physical mesh model, the bounding boxes corresponding to the faces being geometrical bodies enclosing the faces; determining, from the generated bounding boxes, the bounding box in which the first rendering vertex is located, to obtain the adjacent bounding box; and determining the face corresponding to the adjacent bounding box as the adjacent face of the first rendering vertex.

Specifically, the terminal may generate the corresponding bounding boxes for the faces of the first physical mesh model, and determine, from the generated bounding boxes, the bounding box in which the first rendering vertex is located, to obtain the adjacent bounding box.

In some aspects, the terminal may separately generate corresponding bounding boxes for some faces of the first physical mesh model, and determine, from the generated bounding boxes, a bounding box in which the first rendering vertex is located, to obtain an adjacent bounding box. For example, the terminal may determine, based on a normal vector of a physical vertex on the face and a face normal vector of the face, a face satisfying an angle condition from the first physical mesh model, and generate a corresponding bounding box for a face of the first physical mesh model other than the face satisfying the angle condition.

The physical vertex has a normal vector, the face also has a normal vector, and the normal vector of the face is referred to as a face normal vector. The angle condition includes at least one of a smallest vector angle being greater than a first angle threshold or a largest vector angle being greater than a second angle threshold. A vector angle is an angle between the normal vector of the physical vertex and the face normal vector.

In this aspect, because the first rendering vertex is located in the bounding box of the adjacent face, the first rendering vertex is adjacent to the adjacent face. Therefore, accuracy of the determined adjacent face is improved.

In some aspects, the generating the corresponding bounding boxes for the faces of the first physical mesh model includes: obtaining, for each face of the first physical mesh model, a normal vector of each physical vertex on the face and a face normal vector of the face; determining a vector angle between the normal vector of each physical vertex and the face normal vector; determining, based on the vector angle, a first face satisfying the angle condition from the first physical mesh model, the angle condition including at least one of the smallest vector angle being greater than the first angle threshold or the largest vector angle being greater than the second angle threshold; and generating a corresponding bounding box for a second face of the first physical mesh model other than the first face.

The first angle threshold is less than the second angle threshold. The first angle threshold and the second angle threshold may be less than or equal to 90 degrees. For example, the first angle threshold is 60 degrees or 50 degrees, and the second angle threshold is 90 degrees or 85 degrees. The first face satisfies at least one of the smallest vector angle being greater than the first angle threshold or the largest vector angle being greater than the second angle threshold.

Specifically, the face of the first physical mesh model is a triangular face. For each face, the face includes a first physical vertex, a second physical vertex, and a third physical vertex. An angle between a normal vector of the first physical vertex and a face normal vector of the face is a first angle. An angle between a normal vector of the second physical vertex and the face normal vector of the face is a second angle. An angle between a normal vector of the third physical vertex and the face normal vector of the face is a third angle. The terminal selects the smallest of the first angle, the second angle, and the third angle to obtain a smallest angle, and selects the largest to obtain a largest angle. When determining that the smallest angle is greater than the first angle threshold or the largest angle is greater than the second angle threshold, the terminal determines that the face is the first face. The terminal generates the corresponding bounding box for the second face of the first physical mesh model other than the first face.

In some aspects, the terminal traverses the faces of the first physical mesh model, and determines the first face and the second face from the faces. To accelerate traversing of the face, the terminal may perform hash calculation on coordinates of each physical vertex on the face, and search for the corresponding face based on a calculated hash value.

In this aspect, because the first face satisfies the angle condition, a normal of the vertex on the first face is far from a normal of the face, which is not conducive to projection of the vertex to the face. However, the second face does not satisfy the angle condition, which is more conducive to projection to the face. Therefore, accuracy of determining the mapping face is improved.

In some aspects, the determining a mapping physical vertex corresponding to the second rendering vertex from physical vertexes in the first physical mesh model includes: determining the target face corresponding to the second rendering vertex from the faces of the first physical mesh model, the second rendering vertex being located in a bounding box of the target face; determining the distances between the physical vertexes on each target face and the second rendering vertex; and determining, based on the distances between the physical vertexes on each target face and the second rendering vertex, the mapping physical vertex corresponding to the second rendering vertex from the physical vertexes on each target face.

Specifically, the terminal may generate the corresponding bounding boxes for the faces of the first physical mesh model, determine, from the bounding boxes of the faces, the bounding box in which the second rendering vertex is located, to obtain the target bounding box, and determine the face corresponding to the target bounding box as the target face corresponding to the second rendering vertex. There may be one target face or a plurality of target faces, and “a plurality of” means “at least two”.

In some aspects, for each physical vertex on each target face, the terminal calculates the distance between the physical vertex and the second rendering vertex. The terminal determines the physical vertex with the minimum distance as the mapping physical vertex corresponding to the second rendering vertex.

In this aspect, the mapping physical vertex corresponding to the second rendering vertex is determined from the physical vertexes on each target face based on the distances between the physical vertexes on each target face and the second rendering vertex, so that the physical vertex with the minimum distance may be determined as the mapping physical vertex. Therefore, the mapping physical vertex is more appropriate.

In some aspects, the transforming the first graphic mesh model based on the model mapping information and transformation of the first physical mesh model, and rendering the soft-body object by using a transformed first graphic mesh model includes: obtaining the second physical mesh model representing the soft-body object in the second form, and moving the physical vertex subjected to the action of the external force in the second physical mesh model, to obtain the first physical mesh model formed under the action of the external force; obtaining the second graphic mesh model representing the soft-body object in the second form, and determining, for a second rendering vertex subjected to the action of the external force in the second graphic mesh model, relative location information between the second rendering vertex and a corresponding mapping physical vertex from the model mapping information; moving, based on the relative location information between the second rendering vertex and the corresponding mapping physical vertex, the second rendering vertex subjected to the action of the external force, to obtain a first graphic mesh model formed under the action of the external force; and rendering the soft-body object by using the first graphic mesh model formed under the action of the external force.

The relative location information between the second rendering vertex and the corresponding mapping physical vertex is configured for establishing the relationship between the coordinates of the mapping physical vertex and the coordinates of the second rendering vertex. For example, the relative location information may be the affine transformation matrix, and the affine transformation matrix is configured for establishing the relationship between the coordinates of the mapping physical vertex and the coordinates of the second rendering vertex. The result obtained by transforming the physical mapping vertex by using the affine transformation matrix is the coordinates of the second rendering vertex. For example, if the affine transformation matrix is M, the coordinates of the mapping physical vertex are P1, and the coordinates of the second rendering vertex are P2, P2=P1*M.

Specifically, locations, that is, coordinates, of a same physical vertex in the first physical mesh model and the second physical mesh model may be different. Therefore, when the mapping physical vertex changes, the second rendering vertex may be correspondingly moved based on the relative location information between the second rendering vertex and the corresponding mapping physical vertex. In this way, the action of the external force is indirectly applied to the second rendering vertex, and the action of the external force is indirectly applied to the second graphic mesh model, so that the first graphic mesh model formed under the action of the external force presents the effect achieved under the action of the external force.

In some aspects, the terminal determines a location of the mapping physical vertex in the second physical mesh model, to obtain a first location, and transforms the first location by using the relative location information between the second rendering vertex and the corresponding mapping physical vertex, to obtain the predicted location of the second rendering vertex. For example, if the relative location information between the second rendering vertex and the corresponding mapping physical vertex is an affine transformation matrix M, and coordinates of the mapping physical vertex in the second physical mesh model are P3, the predicted location of the second rendering vertex is P4=P3*M, where P4 is the predicted location of the second rendering vertex.

In some aspects, the terminal may determine the part of the soft-body object subjected to the action of the external force, to obtain the external-force affected part, and determine each second rendering vertex for representing the external-force affected part in the second graphic mesh model as a second rendering vertex subjected to the action of the external force.

In some aspects, at least one first rendering vertex in the second graphic mesh model is subjected to the action of the external force, and at least one second rendering vertex in the second graphic mesh model is subjected to the action of the external force. The terminal moves the physical vertex subjected to the action of the external force in the second physical mesh model, to obtain the first physical mesh model formed under the action of the external force; determines, for the first rendering vertex subjected to the action of the external force in the second graphic mesh model, the relative location information between the first rendering vertex and the corresponding mapping face from the model mapping information; moves, based on the relative location information between the first rendering vertex and the corresponding mapping face, the first rendering vertex subjected to the action of the external force; determines, for the second rendering vertex subjected to the action of the external force in the second graphic mesh model, the relative location information between the second rendering vertex and the corresponding mapping physical vertex from the model mapping information; and moves, based on the relative location information between the second rendering vertex and the corresponding mapping physical vertex, the second rendering vertex subjected to the action of the external force, to obtain the first graphic mesh model formed under the action of the external force.

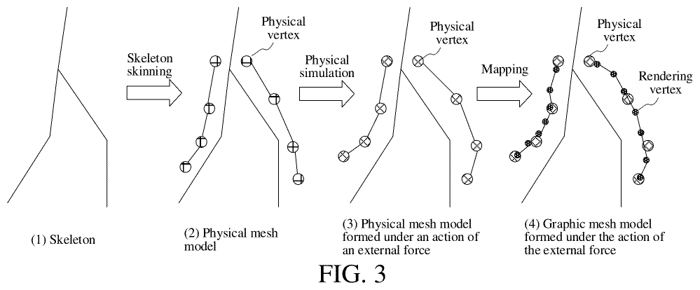

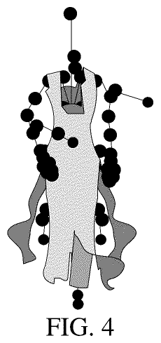

In some aspects, when the soft-body object is the multilayer clothes of the character, during real-time rendering, the terminal first performs skeleton skinning on the character by using the second physical mesh model. Skeleton skinning means binding a skeleton of the character to a physical vertex in the second physical mesh model, so that a movement of the skeleton drives a movement of the physical vertex. (1) in FIG. 3 shows the skeleton. (2) in FIG. 3 shows a result obtained by skinning the skeleton by using the second physical mesh model, and includes the skeleton and the second physical mesh model. Then, the terminal performs physical simulation on the second physical mesh model. (3) in FIG. 3 shows a result of physical simulation. It can be learned from (2) in FIGS. 3 and (3) in FIG. 3 that some physical vertexes in the second physical mesh model are moved. After obtaining, through physical simulation, the first physical mesh model formed under the action of the external force, the terminal may move, based on the model mapping information and the first physical mesh model formed under the action of the external force, the rendering vertex in the second graphic mesh model to obtain the first graphic mesh model formed under the action of the external force. (4) in FIG. 3 shows the first graphic mesh model formed under the action of the external force. For ease of observation, (4) in FIG. 3 further shows the first physical mesh model formed under the action of the external force. An entire process in FIG. 3 may be referred to as cloth simulation mapping. Cloth simulation mapping is a computer graphics technology for simulating and rendering various types of cloth materials. Cloth movement and deformation effects can be achieved by finely controlling the deformable surface in combination with a physical simulation algorithm. In addition, a plurality of factors such as illumination, a shadow, and reflection also need to be considered in a rendering process, to further improve visual effects. It can be learned that cloth simulation mapping includes three phases: skinning, physical simulation, and mapping. An example in which the soft-body object is the multilayer clothes is used. FIG. 4 shows the first graphic mesh model formed under the action of the external force.

In this aspect, because the precision of the first physical mesh model is lower than the precision of the first graphic mesh model, the quantity of vertexes subjected to the action of the external force in the first physical mesh model is less than the quantity of vertexes subjected to the action of the external force in the first graphic mesh model. For example, a part of the soft-body object is subjected to the action of the external force, a quantity of vertexes representing the part in the first physical mesh model is 10, and a quantity of vertexes representing the part in the first graphic mesh model is 100. Because complexity of moving a vertex based on the external force is high, a vertex in the second physical mesh model is first moved based on the external force, and then a vertex in the second graphic mesh model is moved based on relative location information. Therefore, the calculation complexity is reduced, and the calculation efficiency is improved.

In some aspects, the method further includes: obtaining a label value of each rendering vertex in the first graphic mesh model in response to setting a label value for the rendering vertex in the first-type mesh region of the first graphic mesh model and in response to setting a label value for the rendering vertex in the second-type mesh region of the first graphic mesh model, the label value set for the rendering vertex in the first-type mesh region being less than a label threshold, and the label value set for the rendering vertex in the second-type mesh region being greater than or equal to the label threshold. The using a rendering vertex in a first-type mesh region of the first graphic mesh model as a first rendering vertex includes: determining, from the first graphic mesh model, the rendering vertex whose label value is less than the label threshold, to obtain the first rendering vertex. The using a rendering vertex in a second-type mesh region of the first graphic mesh model as a second rendering vertex includes: determining, from the first graphic mesh model, the rendering vertex whose label value is greater than or equal to the label threshold, to obtain the second rendering vertex.

The label values are all numerical values. For example, they may be integers, or may be positive integers greater than or equal to 0. A same label value may be set for each rendering vertex in the first-type mesh region. Setting a label value for a mesh region means setting a label value for a vertex in the mesh region. The label threshold may be set as required. For example, the label threshold is 10000. In this case, a label value of the first rendering vertex is less than 10000, and a label value of the second rendering vertex is greater than or equal to 10000. A same label value or a different label value may be set for each first-type mesh region. For example, if two first-type mesh regions represent a same component of the soft-body object, a same label value may be set for the two first-type mesh regions. For example, the soft-body object is the multilayer clothes, a component of the multilayer clothes includes trousers, and if the trousers are represented by two first-type mesh regions, a same label value may be set for the two first-type mesh regions. If two first-type mesh regions represent different components of the soft-body object, for example, one is used for representing trousers, and the other is used for representing a ribbon, different label values are set for the two first-type mesh regions.

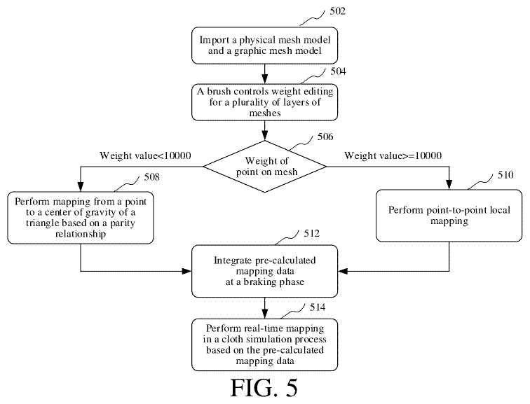

Specifically, the terminal may set the label value by using three-dimensional modeling software. For example, a brush tool for setting a vertex weight may be provided in the three-dimensional modeling software, the weight set in the brush tool may be set as a label value, and a label value is set for a mesh region by using the brush tool. The three-dimensional modeling software may be, for example, 3ds Max. 3ds Max is software for three-dimensional modeling, animation, rendering, and visualization. In FIG. 5, the first physical mesh model and the first graphic mesh model are imported in operation 502. “A plurality of layers of meshes” in “a brush controls weight editing for a plurality of layers of meshes” in operation 504 means the first physical mesh model or the first graphic mesh model. The first physical mesh model may include a plurality of layers of meshes, and “a plurality of layers” means “at least two layers”. For example, the soft-body object is complex clothes, and the complex clothes include a skirt and a ribbon. In this case, two layers of meshes are used in the first physical mesh model to respectively represent the skirt and the ribbon. “Weight” means a label value. Operation 504 means setting the label value by using the brush tool.

In some aspects, the terminal uses the rendering vertex whose label value is less than the label threshold in the first graphic mesh model as the first rendering vertex, and uses the rendering vertex whose label value is greater than or equal to the label threshold in the first graphic mesh model as the second rendering vertex. In FIG. 5, “weight of point on mesh” in operation 506 is a label value of a rendering vertex. In “weight value>=10000”, the weight value is the label value, and 10000 is the label threshold. If the weight value>=10000, operation 510 is performed. “Performing point-to-point local mapping” in operation 510 means determining the mapping physical vertex corresponding to the second rendering vertex.

In this aspect, the label values are set, so that the first-type mesh region is conveniently and accurately distinguished from the second-type mesh region. The rendering vertex whose label value is less than the label threshold is determined from the first graphic mesh model, to obtain the first rendering vertex, and the rendering vertex whose label value is greater than or equal to the label threshold is determined from the first graphic mesh model, to obtain the second rendering vertex. In this way, the first rendering vertex and the second rendering vertex that respectively belong to different types of mesh regions are accurately obtained.

In some aspects, if a first-type mesh region of the first physical mesh model and the first-type mesh region of the first graphic mesh model represent a same part of the soft-body object, a label value of the first-type mesh region of the first physical mesh model corresponds to a label value of the first-type mesh region of the first graphic mesh model. The determining a mapping face corresponding to the first rendering vertex from faces of the first physical mesh model includes: determining the label value of the first rendering vertex to obtain a first label value, and determining a label value corresponding to the first label value to obtain a second label value; determining, from the first physical mesh model, faces whose label values are the second label value, to obtain candidate faces; and determining the mapping face corresponding to the first rendering vertex from the candidate faces, so that the projection point of the first rendering vertex on the plane on which the corresponding mapping face is located is located on the mapping face corresponding to the first rendering vertex.

Similar to the first graphic mesh model, the first physical mesh model may be divided into the first-type mesh region and a second-type mesh region. Each physical vertex on the candidate face has a second label value.

Specifically, a label value is also set for each physical vertex in the first physical mesh model. The terminal obtains the label value of each physical vertex in the first physical mesh model in response to setting the label value for the first-type mesh region of the first physical mesh model and in response to setting a label value for the second-type mesh region of the first physical mesh model. Similarly, for the first physical mesh model, a label value set for a physical vertex in the first-type mesh region is less than the label threshold, and a label value set for a physical vertex in the second-type mesh region is greater than or equal to the label threshold.

In some aspects, if the first-type mesh region of the first physical mesh model and the first-type mesh region of the first graphic mesh model represent the same part of the soft-body object, the label value of the first-type mesh region of the first physical mesh model corresponds to the label value of the first-type mesh region of the first graphic mesh model. Therefore, because the first label value corresponds to the second label value, the candidate face and the first rendering vertex correspond to a same part of the soft-body object.

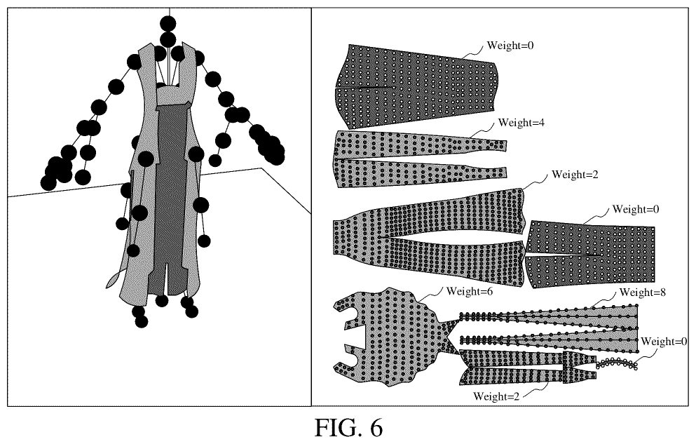

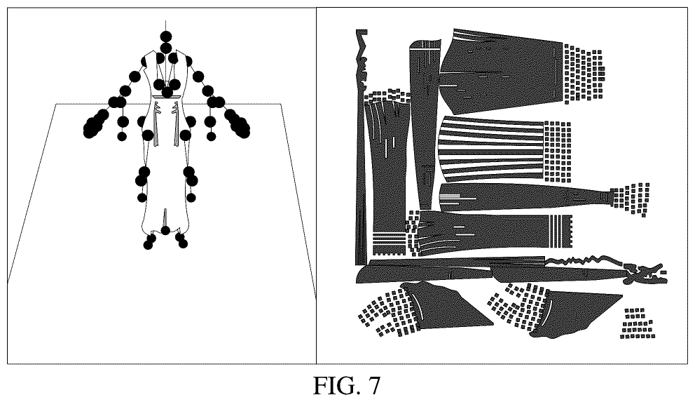

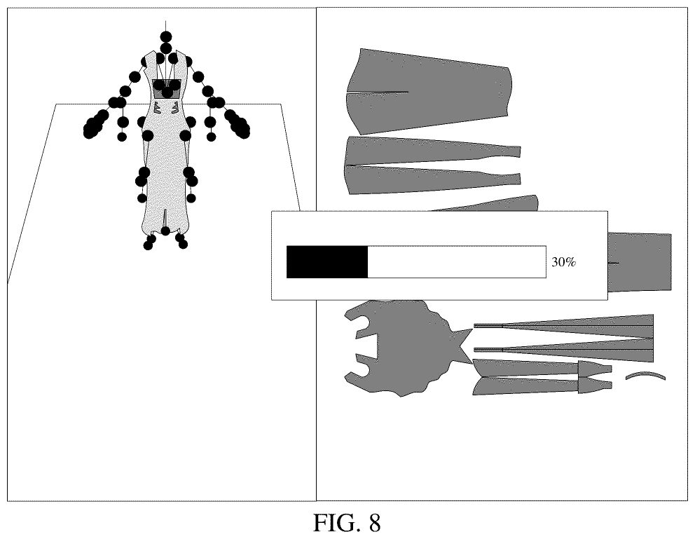

In some aspects, the label value set for the first-type mesh region of the first physical mesh model is an even number, and the label value set for the first-type mesh region of the first graphic mesh model is an odd number. If a first-type mesh region A of the first physical mesh model and a first-type mesh region B of the first graphic mesh model represent a same part of the soft-body object, a label value of the mesh region A and a label value of the mesh region B are adjacent odd and even numbers. For example, the label value of the mesh region A is 2n, and the label value of the mesh region B is 2n+1. As shown in FIG. 5, if the weight value<10000, operation 508 is performed; or if the weight value>=10000, operation 510 is performed. “Parity relationship” in “performing mapping from a point to a center of gravity of a triangle based on a parity relationship” in operation 508 is a relationship corresponding to 2n and 2n+1. When the first label value is less than 10000, for example, the first label value is 4, based on the “parity relationship”, the second label value is 5. “Mapping from a point to a center of gravity of a triangle” in operation 508 means determining the mapping face corresponding to the first rendering vertex from the first physical mesh model, where the first relative location information is the barycentric coordinates of the projection point. “Integrating pre-calculated mapping data at a baking phase” in operation 512 means generating, based on each piece of relative location information, the model mapping information corresponding to the soft-body object. The pre-calculated mapping data is the model mapping information. “Performing real-time mapping in a cloth simulation process based on the pre-calculated mapping data” in operation 514 means performing real-time mapping based on the model mapping information. The real-time mapping process is: determining, for the first rendering vertex subjected to the action of the external force in the second graphic mesh model, the relative location information between the first rendering vertex and the corresponding mapping face from the model mapping information; moving, based on the relative location information between the first rendering vertex and the corresponding mapping face, the first rendering vertex subjected to the action of the external force; determining, for the second rendering vertex subjected to the action of the external force in the second graphic mesh model, the relative location information between the second rendering vertex and the corresponding mapping physical vertex from the model mapping information; and moving, based on the relative location information between the second rendering vertex and the corresponding mapping physical vertex, the second rendering vertex subjected to the action of the external force, to obtain the first graphic mesh model formed under the action of the external force. FIG. 6 is a schematic diagram of setting a label value for a physical mesh model. FIG. 6 shows a physical mesh model corresponding to the multilayer clothes on the character, and shows a weight, that is, a label value, set for each mesh region of the physical mesh model. Similarly, FIG. 7 shows a graphic mesh model corresponding to the multilayer clothes on the character, and shows each mesh region in the graphic mesh model. A corresponding weight, that is, a corresponding label value, may be set for each mesh region by using the brush tool. An example in which the soft-body object is the multilayer clothes on the character is used. FIG. 8 is a schematic diagram of “integrating pre-calculated mapping data at a baking phase”, that is, obtaining the model mapping information. 30% in FIG. 8 indicates a progress of obtaining the model mapping information.

In some aspects, after obtaining the candidate faces, the terminal determines the adjacent face of the first rendering vertex from the candidate faces, the first rendering vertex being located in the bounding box of the adjacent face. Then, the terminal projects the first rendering vertex to the plane on which the adjacent face is located, to obtain the projection point of the first rendering vertex on the plane on which the adjacent face is located. The terminal may determine the mapping face corresponding to the first rendering vertex from each adjacent face. The projection point of the first rendering vertex on the plane on which the mapping face is located is located on the mapping face.

In this aspect, because the candidate face and the first rendering vertex correspond to a same part of the soft-body object, the mapping face and the first rendering vertex correspond to the same part of the soft-body object, for example, both correspond to the trousers. This makes the mapping face and the model mapping information more appropriate, so that rendering effects can be improved.

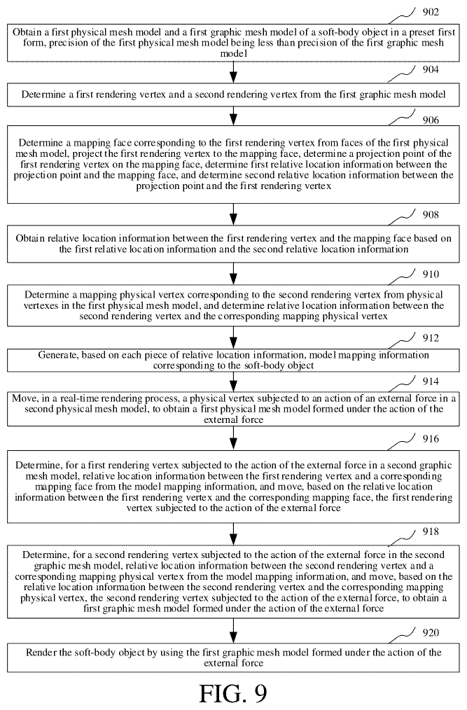

In some aspects, as shown in FIG. 9, a soft-body object rendering method is provided. The method may be performed by a terminal, or may be performed jointly by a terminal and a server. An application of the method to the terminal is used as an example for description. The method includes the following operations.

Operation 902: Obtain a first physical mesh model and a first graphic mesh model of a soft-body object in a preset first form, precision of the first physical mesh model being less than precision of the first graphic mesh model.

Operation 904: Determine a first rendering vertex and a second rendering vertex from the first graphic mesh model.

The first rendering vertex is a rendering vertex in a first-type mesh region of the first graphic mesh model. The second rendering vertex is a rendering vertex in a second-type mesh region of the first graphic mesh model. Complexity of the second-type mesh region is higher than complexity of the first-type mesh region.

Operation 906: Determine a mapping face corresponding to the first rendering vertex from faces of the first physical mesh model, project the first rendering vertex to the mapping face, determine a projection point of the first rendering vertex on the mapping face, determine first relative location information between the projection point and the mapping face, and determine second relative location information between the projection point and the first rendering vertex.

A location of the projection point is correlated with a location of the mapping face by using the first relative location information, and a location of the first rendering vertex is correlated with the location of the projection point by using the second relative location information.

Operation 908: Obtain relative location information between the first rendering vertex and the mapping face based on the first relative location information and the second relative location information.

Operation 910: Determine a mapping physical vertex corresponding to the second rendering vertex from physical vertexes in the first physical mesh model, and determine relative location information between the second rendering vertex and the corresponding mapping physical vertex.

Operation 912: Generate, based on each piece of relative location information, model mapping information corresponding to the soft-body object.

Operation 914: Move, in a real-time rendering process, a physical vertex subjected to an action of an external force in a second physical mesh model, to obtain a first physical mesh model formed under the action of the external force.

Operation 916: Determine, for a first rendering vertex subjected to the action of the external force in a second graphic mesh model, relative location information between the first rendering vertex and a corresponding mapping face from the model mapping information, and move, based on the relative location information between the first rendering vertex and the corresponding mapping face, the first rendering vertex subjected to the action of the external force.

Operation 918: Determine, for a second rendering vertex subjected to the action of the external force in the second graphic mesh model, relative location information between the second rendering vertex and a corresponding mapping physical vertex from the model mapping information, and move, based on the relative location information between the second rendering vertex and the corresponding mapping physical vertex, the second rendering vertex subjected to the action of the external force, to obtain a first graphic mesh model formed under the action of the external force.

Operation 920: Render the soft-body object by using the first graphic mesh model formed under the action of the external force.

In this aspect, a vertex-vertex relationship is established for a high-complexity mesh region, and a vertex-face relationship is established for a low-complexity mesh region. This makes the model mapping information more appropriate. Therefore, using the model mapping information to transform the first graphic mesh model based on transformation of the first physical mesh model during rendering can improve effects of a transformed first graphic mesh model, and rendering the transformed first graphic mesh model can improve rendering effects.

The soft-body object rendering method provided described herein may be applied to any virtual scene to generate a soft-body object in the virtual scene. The virtual scene includes but is not limited to scenes such as a movie and television special effect, a game, a visual design, virtual reality, and digital cultural innovation.

For example, in a game scene, the soft-body object may be multilayer clothes on a character, and the multilayer clothes may be single-layer or multilayer. To render the multilayer clothes in the game scene in real time, the terminal may obtain a first physical mesh model and a first graphic mesh model of the multilayer clothes, and determine a first rendering vertex and a second rendering vertex from the first graphic mesh model. The terminal may determine a mapping face corresponding to the first rendering vertex from faces of the first physical mesh model, project the first rendering vertex to the mapping face, determine a projection point of the first rendering vertex on the mapping face, determine first relative location information between the projection point and the mapping face, and determine second relative location information between the projection point and the first rendering vertex. The terminal may obtain relative location information between the first rendering vertex and the mapping face based on the first relative location information and the second relative location information. The terminal may determine a mapping physical vertex corresponding to the second rendering vertex from physical vertexes in the first physical mesh model, determine relative location information between the second rendering vertex and the corresponding mapping physical vertex, and generate, based on each piece of relative location information, model mapping information corresponding to the multilayer clothes.

In a real-time rendering process of the multilayer clothes, the terminal obtains a second physical mesh model of the multilayer clothes in a current state and a second graphic mesh model of the multilayer clothes in the current state. The terminal moves a physical vertex subjected to an action of an external force in the second physical mesh model, to obtain a first physical mesh model formed under the action of the external force; determines, for a first rendering vertex subjected to the action of the external force in the second graphic mesh model, relative location information between the first rendering vertex and a corresponding mapping face from the model mapping information; moves, based on the relative location information between the first rendering vertex and the corresponding mapping face, the first rendering vertex subjected to the action of the external force; determines, for a second rendering vertex subjected to the action of the external force in the second graphic mesh model, relative location information between the second rendering vertex and a corresponding mapping physical vertex from the model mapping information; moves, based on the relative location information between the second rendering vertex and the corresponding mapping physical vertex, the second rendering vertex subjected to the action of the external force, to obtain a first graphic mesh model formed under the action of the external force; and renders the first graphic mesh model formed under the action of the external force, to obtain a rendering result of the multilayer clothes.

Applying the soft-body object rendering method provided described herein to the game scene can improve flexibility and diversity of game production, improve production efficiency and quality, improve mapping effects and stability, and improve simulation effects and precision, and the like, and provides more possibilities and better flexibility for implementation of cloth simulation.

In some application scenarios, an example in which the soft-body object is a curtain on a building is used. The terminal may obtain a first physical mesh model and a first graphic mesh model of the curtain, and determine a first rendering vertex and a second rendering vertex from the first graphic mesh model. The terminal may determine a mapping face corresponding to the first rendering vertex from faces of the first physical mesh model, project the first rendering vertex to the mapping face, determine a projection point of the first rendering vertex on the mapping face, determine first relative location information between the projection point and the mapping face, and determine second relative location information between the projection point and the first rendering vertex. The terminal may obtain relative location information between the first rendering vertex and the mapping face based on the first relative location information and the second relative location information. The terminal may determine a mapping physical vertex corresponding to the second rendering vertex from physical vertexes in the first physical mesh model, determine relative location information between the second rendering vertex and the corresponding mapping physical vertex, and generate, based on each piece of relative location information, model mapping information corresponding to the curtain.

In a real-time rendering process of the curtain, the terminal obtains a second physical mesh model of the curtain in a current state and a second graphic mesh model of the curtain in the current state. The terminal moves a physical vertex subjected to an action of an external force in the second physical mesh model, to obtain a first physical mesh model formed under the action of the external force; determines, for a first rendering vertex subjected to the action of the external force in the second graphic mesh model, relative location information between the first rendering vertex and a corresponding mapping face from the model mapping information; moves, based on the relative location information between the first rendering vertex and the corresponding mapping face, the first rendering vertex subjected to the action of the external force; determines, for a second rendering vertex subjected to the action of the external force in the second graphic mesh model, relative location information between the second rendering vertex and a corresponding mapping physical vertex from the model mapping information; moves, based on the relative location information between the second rendering vertex and the corresponding mapping physical vertex, the second rendering vertex subjected to the action of the external force, to obtain a first graphic mesh model formed under the action of the external force; and renders the first graphic mesh model formed under the action of the external force, to obtain a rendering result of the curtain.

Although the operations in the flowchart in each of the foregoing aspects are sequentially presented according to indications of arrowheads, these operations are not necessarily performed according to sequences indicated by the arrowheads. Unless otherwise explicitly specified described herein, execution of the operations is not strictly limited, and the operations may be performed in other sequences. Moreover, at least some of the operations in each aspect may include a plurality of operations or a plurality of stages. The operations or stages are not necessarily performed at the same moment but may be performed at different moments. The operations or stages are not necessarily performed in sequence, but may be performed alternately with other operations or at least some operations or stages of other operations.

Based on a same inventive concept, an aspect described herein further provides a soft-body object rendering apparatus for implementing the foregoing soft-body object rendering method. An implementation solution provided by the apparatus for resolving the problem is similar to the implementation solution described in the foregoing method. Therefore, for specific definition of one or more aspects of the soft-body object rendering apparatus provided below, refer to the definition of the soft-body object rendering method above. Details are not described herein again.

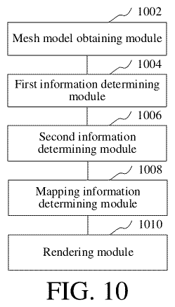

In some aspects, as shown in FIG. 10, a soft-body object rendering apparatus is provided, including a mesh model obtaining module 1002, a first information determining module 1004, a second information determining module 1006, a mapping information determining module 1008, and a simulation module 1010.

The mesh model obtaining module 1002 is configured to obtain a first physical mesh model and a first graphic mesh model of a soft-body object in a preset first form, precision of the first physical mesh model being less than precision of the first graphic mesh model.

The first information determining module 1004 is configured to: use a rendering vertex in a first-type mesh region of the first graphic mesh model as a first rendering vertex, determine a mapping face corresponding to the first rendering vertex from faces of the first physical mesh model, and determine relative location information between the first rendering vertex and the mapping face.

The second information determining module 1006 is configured to: use a rendering vertex in a second-type mesh region of the first graphic mesh model as a second rendering vertex, determine a mapping physical vertex corresponding to the second rendering vertex from physical vertexes in the first physical mesh model, and determine relative location information between the second rendering vertex and the corresponding mapping physical vertex, complexity of the second-type mesh region being higher than complexity of the first-type mesh region.

The mapping information determining module 1008 is configured to generate, based on each piece of relative location information, model mapping information corresponding to the soft-body object.

The rendering module 1010 is configured to: transform, when rendering the soft-body object, the first graphic mesh model based on the model mapping information and transformation of the first physical mesh model, and render the soft-body object by using a transformed first graphic mesh model.

In some aspects, the first information determining module 1004 is further configured to: project the first rendering vertex to the mapping face, and determine a projection point of the first rendering vertex on the mapping face; determine first relative location information between the projection point and the mapping face, and determine second relative location information between the projection point and the first rendering vertex; and obtain the relative location information between the first rendering vertex and the mapping face based on the first relative location information and the second relative location information.

In some aspects, the first information determining module 1004 is further configured to determine the first relative location information between the projection point and the mapping face by using coordinates of each physical vertex on the mapping face and coordinates of the projection point, the first relative location information between the projection point and the mapping face being configured for establishing a linear relationship between the coordinates of each physical vertex on the mapping face and the coordinates of the projection point.

In some aspects, the rendering module 1010 is further configured to: obtain a second physical mesh model representing the soft-body object in a second form, and move a physical vertex subjected to an action of an external force in the second physical mesh model, to obtain a first physical mesh model formed under the action of the external force; obtain a second graphic mesh model representing the soft-body object in the second form, and determine, for a first rendering vertex subjected to the action of the external force in the second graphic mesh model, relative location information between the first rendering vertex and a corresponding mapping face from the model mapping information; move, based on the relative location information between the first rendering vertex and the corresponding mapping face, the first rendering vertex subjected to the action of the external force, to obtain a first graphic mesh model formed under the action of the external force; and render the soft-body object by using the first graphic mesh model formed under the action of the external force.

In some aspects, the first information determining module 1004 is further configured to: determine an adjacent face of the first rendering vertex from the faces of the first physical mesh model, the first rendering vertex being located in a bounding box of the adjacent face; and determine, based on the adjacent face of the first rendering vertex, the mapping face corresponding to the first rendering vertex.

In some aspects, the first information determining module 1004 is further configured to: project, for each adjacent face, the first rendering vertex to a plane on which the adjacent face is located, to obtain a projection point of the first rendering vertex on the plane on which the adjacent face is located; and determine the mapping face corresponding to the first rendering vertex from each adjacent face, a projection point of the first rendering vertex on a plane on which the mapping face is located being located on the mapping face.

In some aspects, the first information determining module 1004 is further configured to: generate, for the faces of the first physical mesh model, bounding boxes enclosing the faces; determine, from the generated bounding boxes, a bounding box in which the first rendering vertex is located, to obtain an adjacent bounding box; and determine a face corresponding to the adjacent bounding box as the adjacent face of the first rendering vertex.

In some aspects, the first information determining module 1004 is further configured to: obtain, for each face of the first physical mesh model, a normal vector of each physical vertex on the face and a face normal vector of the face; determine a vector angle between the normal vector of each physical vertex and the face normal vector; determine, based on the vector angle, a first face satisfying an angle condition from the first physical mesh model, the angle condition including at least one of a smallest vector angle being greater than a first angle threshold or a largest vector angle being greater than a second angle threshold; and generate, for a second face of the first physical mesh model other than the first face, a bounding box enclosing the second face.

In some aspects, the second information determining module 1006 is further configured to: determine a target face corresponding to the second rendering vertex from the faces of the first physical mesh model, the second rendering vertex being located in a bounding box of the target face; determine distances between physical vertexes on each target face and the second rendering vertex; and determine, based on the distances between the physical vertexes on each target face and the second rendering vertex, the mapping physical vertex corresponding to the second rendering vertex from the physical vertexes on each target face.

In some aspects, the rendering module 1010 is further configured to: obtain the second physical mesh model representing the soft-body object in the second form, and move the physical vertex subjected to the action of the external force in the second physical mesh model, to obtain the first physical mesh model formed under the action of the external force; obtain the second graphic mesh model representing the soft-body object in the second form, and determine, for a second rendering vertex subjected to the action of the external force in the second graphic mesh model, relative location information between the second rendering vertex and a corresponding mapping physical vertex from the model mapping information; move, based on the relative location information between the second rendering vertex and the corresponding mapping physical vertex, the second rendering vertex subjected to the action of the external force, to obtain a first graphic mesh model formed under the action of the external force; and render the soft-body object by using the first graphic mesh model formed under the action of the external force.

In some aspects, the apparatus 1000 further includes a label processing module, configured to obtain a label value of each rendering vertex in the first graphic mesh model in response to setting a label value for the rendering vertex in the first-type mesh region of the first graphic mesh model and in response to setting a label value for the rendering vertex in the second-type mesh region of the first graphic mesh model, the label value set for the rendering vertex in the first-type mesh region being less than a label threshold, and the label value set for the rendering vertex in the second-type mesh region being greater than or equal to the label threshold.

In some aspects, the first information determining module 1004 is further configured to determine, from the first graphic mesh model, the rendering vertex whose label value is less than the label threshold, to obtain the first rendering vertex.

In some aspects, the second information determining module 1006 is further configured to determine, from the first graphic mesh model, the rendering vertex whose label value is greater than or equal to the label threshold, to obtain the second rendering vertex.

In some aspects, if a first-type mesh region of the first physical mesh model and the first-type mesh region of the first graphic mesh model represent a same part of the soft-body object, a label value of the first-type mesh region of the first physical mesh model corresponds to a label value of the first-type mesh region of the first graphic mesh model.

The first information determining module 1004 is further configured to: determine a label value of the first rendering vertex to obtain a first label value, and determine a label value corresponding to the first label value to obtain a second label value; determine, from the first physical mesh model, faces whose label values are the second label value, to obtain candidate faces; and determine the mapping face corresponding to the first rendering vertex from the candidate faces, so that the projection point of the first rendering vertex on the plane on which the corresponding mapping face is located is located on the mapping face corresponding to the first rendering vertex.

Each module in the soft-body object rendering apparatus may be implemented entirely or partially by using software, hardware, or a combination thereof. Each module may be embedded into or independent of a processor in a computer device in a hardware form, or may be stored in a software form in a memory in a computer device, for a processor to invoke to perform an operation corresponding to the module.

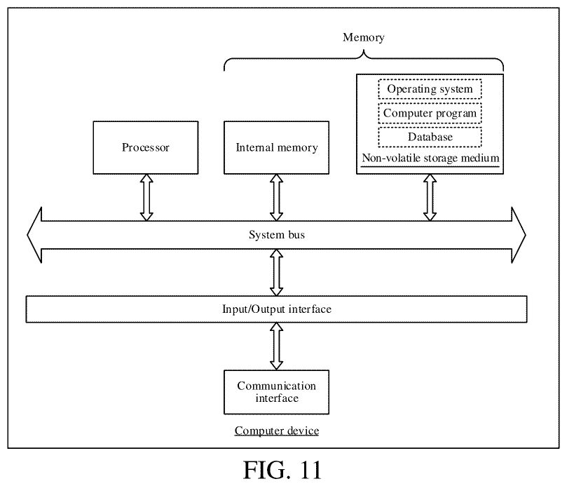

In some aspects, a computer device is provided. The computer device may be a server. A diagram of an internal structure of the computer device may be shown in FIG. 11. The computer device includes a processor, a memory, an input/output (I/O for short) interface, and a communication interface. The processor, the memory, and the input/output interface are connected via a system bus. The communication interface is connected to the system bus through the input/output interface. The processor of the computer device is configured to provide calculation and control capabilities. The memory of the computer device includes a non-volatile storage medium and an internal memory. The non-volatile storage medium has an operating system, a computer program, and a database stored therein. The internal memory provides a running environment for the operating system and the computer program in the non-volatile storage medium. The database of the computer device is configured to store data involved in a soft-body object rendering method. The input/output interface of the computer device is configured to exchange information between the processor and an external device. The communication interface of the computer device is configured to be connected to an external terminal for communication through a network. The computer program, when executed by the processor, causes the soft-body object rendering method to be implemented.

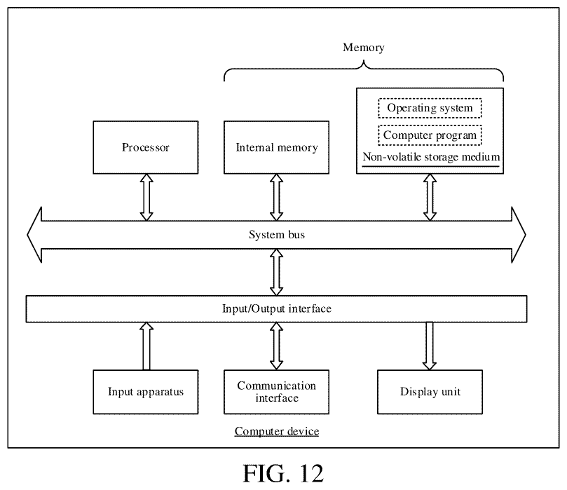

In some aspects, a computer device is provided. The computer device may be a terminal. A diagram of an internal structure of the computer device may be shown in FIG. 12. The computer device includes a processor, a memory, an input/output interface, a communication interface, a display unit, and an input apparatus. The processor, the memory, and the input/output interface are connected via a system bus. The communication interface, the display unit, and the input apparatus are connected to the system bus through the input/output interface. The processor of the computer device is configured to provide calculation and control capabilities. The memory of the computer device includes a non-volatile storage medium and an internal memory. The non-volatile storage medium has an operating system and a computer program stored therein. The internal memory provides a running environment for the operating system and the computer program in the non-volatile storage medium. The input/output interface of the computer device is configured to exchange information between the processor and an external device. The communication interface of the computer device is configured to communicate with an external terminal in a wired or wireless manner. The wireless manner may be implemented by using Wi-Fi, a mobile cellular network, near field communication (NFC), or another technology. The computer program, when executed by the processor, causes a soft-body object rendering method to be implemented. The display unit of the computer device is configured to form a visually visible image, and may be a display screen, a projection apparatus, or a virtual reality imaging apparatus. The display screen may be a liquid crystal display screen or an e-ink display screen. The input apparatus of the computer device may be a touch layer covering the display screen, may be a button, a trackball, or a touchpad disposed on a housing of the computer device, or may be an external keyboard, a touchpad, a mouse, or the like.

The structures shown in FIG. 11 and FIG. 12 are merely block diagrams of a partial structure related to the solutions described herein, and do not constitute a limitation on the computer device to which the solutions described herein are applied. Specifically, the computer device may include more or fewer components than those shown in the figures, have some components combined, or have a different component arrangement.

In some aspects, a computer device is provided, including a memory and a processor. The memory has a computer program stored therein. The processor, when executing the computer program, implements the operations of the foregoing soft-body object rendering method.

In some aspects, a computer-readable storage medium is provided, having a computer program stored therein. The computer program, when executed by a processor, causes the operations of the foregoing soft-body object rendering method to be implemented.

In some aspects, a computer program product is provided, including a computer program. The computer program, when executed by a processor, causes the operations of the foregoing soft-body object rendering method to be implemented.

User information (including, but not limited to, user equipment information, user personal information, and the like) and data (including, but not limited to, data for analysis, stored data, displayed data, and the like) involved described herein are all information and data authorized by users or fully authorized by all parties, and collection, use, and processing of relevant data need to comply with relevant laws, regulations, and standards of relevant countries and regions.

All or some of procedures of the method in the foregoing aspects may be implemented by a computer program instructing relevant hardware. The computer program may be stored in a non-volatile computer-readable storage medium. When the computer program is executed, the procedures of the foregoing method aspects may be performed. References to the memory, the database, or another medium used in the aspects provided described herein may all include at least one of a non-volatile memory and a volatile memory. The non-volatile memory may include a read-only memory (ROM), a magnetic tape, a floppy disk, a flash memory, an optical memory, a high-density embedded non-volatile memory, a resistive random-access memory (ReRAM), a magnetoresistive random-access memory (MRAM), a ferroelectric random-access memory (FRAM), a phase change memory (PCM), a graphene memory, and the like. The volatile memory may include a random access memory (RAM), an external cache, or the like. For the purpose of illustration but not limitation, the RAM may be in various forms, for example, a static random access memory (SRAM) or a dynamic random access memory (DRAM). The database involved in the aspects provided described herein may include at least one of a relational database and a non-relational database. The non-relational database may include but is not limited to a blockchain-based distributed database and the like. The processor involved in the aspects provided by this application may be but is not limited to a general-purpose processor, a central processing unit, a graphics processor, a digital signal processor, a programmable logic device, a quantum computing-based data processing logic device, and the like.

Technical features of the foregoing aspects may be randomly combined. To make description concise, not all possible combinations of the technical features in the foregoing aspects are described. However, the combinations of these technical features shall be considered as falling within the scope recorded by this specification provided that no conflict exists.

The foregoing aspects only describe several implementations described herein, which are described specifically and in detail, but cannot be construed as a limitation to the patent scope described herein. For a person of ordinary skill in the art, several transformations and improvements can be made without departing from the idea described herein. These transformations and improvements belong to the protection scope described herein. Therefore, the protection scope of the patent described herein shall be subject to the appended claims.

What is claimed is:

1. A computer-implemented method, comprising:
obtaining a first physical mesh model and a first graphic mesh model of a soft-body object in a preset first form, wherein a level of precision of the first physical mesh model is less than a level of precision of the first graphic mesh model;
identifying a rendering vertex in a first-type mesh region of the first graphic mesh model as a first rendering vertex;
determining a mapping face corresponding to the first rendering vertex from faces of the first physical mesh model;
determining relative location information between the first rendering vertex and the mapping face;
identifying a rendering vertex in a second-type mesh region of the first graphic mesh model as a second rendering vertex;
determining a mapping physical vertex corresponding to the second rendering vertex from physical vertexes in the first physical mesh model;
determining relative location information between the second rendering vertex and the corresponding mapping physical vertex, wherein a complexity of the second-type mesh region is higher than a complexity of the first-type mesh region;
generating, based on each piece of relative location information, model mapping information corresponding to the soft-body object;
transforming, when rendering the soft-body object, the first graphic mesh model based on the model mapping information and transformation of the first physical mesh model; and
rendering the soft-body object by using the transformed first graphic mesh model.

2. The method according to claim 1, wherein the determining relative location information between the first rendering vertex and the mapping face comprises:
projecting the first rendering vertex to the mapping face, and determining a projection point of the first rendering vertex on the mapping face;
determining first relative location information between the projection point and the mapping face;
determining second relative location information between the projection point and the first rendering vertex; and
obtaining the relative location information between the first rendering vertex and the mapping face based on the first relative location information and the second relative location information.

3. The method according to claim 2, wherein the determining first relative location information between the projection point and the mapping face comprises:
determining the first relative location information between the projection point and the mapping face by using coordinates of each physical vertex on the mapping face and coordinates of the projection point,
the first relative location information between the projection point and the mapping face being configured for establishing a linear relationship between the coordinates of each physical vertex on the mapping face and the coordinates of the projection point.

4. The method according to claim 2, wherein the transforming the first graphic mesh model based on the model mapping information and transformation of the first physical mesh model, and rendering the soft-body object by using a transformed first graphic mesh model comprises:
obtaining a second physical mesh model representing the soft-body object in a second form, and moving a physical vertex subjected to an action of an external force in the second physical mesh model, to obtain a first physical mesh model formed under the action of the external force;
obtaining a second graphic mesh model representing the soft-body object in the second form, and determining, for a first rendering vertex subjected to the action of the external force in the second graphic mesh model, relative location information between the first rendering vertex and a corresponding mapping face from the model mapping information; and
moving, based on the relative location information between the first rendering vertex and the corresponding mapping face, the first rendering vertex subjected to the action of the external force, to obtain a first graphic mesh model formed under the action of the external force.

5. The method of claim 4, wherein the rendering comprises rendering the soft-body object using the first graphic mesh model formed under the action of the external force.

6. The method of claim 1, wherein the determining a mapping face corresponding to the first rendering vertex from faces of the first physical mesh model comprises:
determining an adjacent face of the first rendering vertex from the faces of the first physical mesh model, the first rendering vertex being located in a bounding box of the adjacent face; and
determining, based on the adjacent face of the first rendering vertex, the mapping face corresponding to the first rendering vertex.

7. The method according to claim 5, wherein the determining, based on the adjacent face of the first rendering vertex, the mapping face corresponding to the first rendering vertex comprises:
projecting, for each adjacent face, the first rendering vertex to a plane on which the adjacent face is located, to obtain a projection point of the first rendering vertex on the plane on which the adjacent face is located; and
determining the mapping face corresponding to the first rendering vertex from the adjacent face, a projection point of the first rendering vertex on a plane on which the mapping face is located being located on the mapping face.

8. The method of claim 6, wherein the determining an adjacent face of the first rendering vertex from the faces of the first physical mesh model comprises:
generating, for the faces of the first physical mesh model, bounding boxes enclosing the faces;
determining, from the generated bounding boxes, a bounding box in which the first rendering vertex is located, to obtain an adjacent bounding box; and
determining a face corresponding to the adjacent bounding box as the adjacent face of the first rendering vertex.

9. The method according to claim 8, wherein the generating, for the faces of the first physical mesh model, bounding boxes enclosing the faces comprises:
obtaining, for each face of the first physical mesh model, a normal vector of each physical vertex on the face and a face normal vector of the face;
determining a vector angle between the normal vector of each physical vertex and the face normal vector;
determining, based on the vector angle, a first face satisfying an angle condition from the first physical mesh model, the angle condition comprising at least one of a smallest vector angle being greater than a first angle threshold or a largest vector angle being greater than a second angle threshold; and
generating, for a second face of the first physical mesh model other than the first face, a bounding box enclosing the second face.

10. The method of claim 1, wherein the determining a mapping physical vertex corresponding to the second rendering vertex from physical vertexes in the first physical mesh model comprises:
determining a target face corresponding to the second rendering vertex from the faces of the first physical mesh model, the second rendering vertex being located in a bounding box of the target face;
determining distances between physical vertexes on each target face and the second rendering vertex; and
determining, based on the distances between the physical vertexes on each target face and the second rendering vertex, the mapping physical vertex corresponding to the second rendering vertex from the physical vertexes on each target face.

11. The method of claim 10, wherein the transforming the first graphic mesh model based on the model mapping information and transformation of the first physical mesh model comprises:
obtaining the second physical mesh model representing the soft-body object in the second form, and moving the physical vertex subjected to the action of the external force in the second physical mesh model, to obtain the first physical mesh model under the action of the external force;
obtaining the second graphic mesh model representing the soft-body object in the second form, and determining, for a second rendering vertex subjected to the action of the external force in the second graphic mesh model, relative location information between the second rendering vertex and a corresponding mapping physical vertex from the model mapping information; and
moving, based on the relative location information between the second rendering vertex and the corresponding mapping physical vertex, the second rendering vertex subjected to the action of the external force, to obtain a first graphic mesh model formed under the action of the external force.

12. The method of claim 11, wherein rendering comprises rendering the soft-body object using the first graphic mesh model formed under the action of the external force.

13. The method of claim 1, further comprising:
obtaining a label value of each rendering vertex in the first graphic mesh model in response to setting a label value for the rendering vertex in the first-type mesh region of the first graphic mesh model and in response to setting a label value for the rendering vertex in the second-type mesh region of the first graphic mesh model, the label value set for the rendering vertex in the first-type mesh region being less than a label threshold, and the label value set for the rendering vertex in the second-type mesh region being greater than or equal to the label threshold,
wherein the identifying a rendering vertex in a first-type mesh region of the first graphic mesh model as a first rendering vertex comprises determining, from the first graphic mesh model, the rendering vertex whose label value is less than the label threshold, to obtain the first rendering vertex; and
wherein the identifying a rendering vertex in a second-type mesh region of the first graphic mesh model as a second rendering vertex comprises determining, from the first graphic mesh model, the rendering vertex whose label value is greater than or equal to the label threshold, to obtain the second rendering vertex.

14. The method according to claim 13, wherein when a first-type mesh region of the first physical mesh model and the first-type mesh region of the first graphic mesh model represent a same part of the soft-body object, a label value of the first-type mesh region of the first physical mesh model corresponds to a label value of the first-type mesh region of the first graphic mesh model; and
the determining a mapping face corresponding to the first rendering vertex from faces of the first physical mesh model comprises:
determining a label value of the first rendering vertex to obtain a first label value, and determining a label value corresponding to the first label value to obtain a second label value;
determining, from the first physical mesh model, faces whose label values are the second label value, to obtain candidate faces; and
determining the mapping face corresponding to the first rendering vertex from the candidate faces, so that the projection point of the first rendering vertex on the plane on which the corresponding mapping face is located is located on the mapping face corresponding to the first rendering vertex.

15. One or more non-transitory computer readable media comprising computer readable instructions that, when executed, configure a data processing system to perform:
obtaining a first physical mesh model and a first graphic mesh model of a soft-body object in a preset first form, wherein a level of precision of the first physical mesh model is less than a level of precision of the first graphic mesh model;
identifying a rendering vertex in a first-type mesh region of the first graphic mesh model as a first rendering vertex;
determining a mapping face corresponding to the first rendering vertex from faces of the first physical mesh model;
determining relative location information between the first rendering vertex and the mapping face;
identifying a rendering vertex in a second-type mesh region of the first graphic mesh model as a second rendering vertex;
determining a mapping physical vertex corresponding to the second rendering vertex from physical vertexes in the first physical mesh model;
determining relative location information between the second rendering vertex and the corresponding mapping physical vertex, wherein a complexity of the second-type mesh region is higher than a complexity of the first-type mesh region;
generating, based on each piece of relative location information, model mapping information corresponding to the soft-body object;
transforming, when rendering the soft-body object, the first graphic mesh model based on the model mapping information and transformation of the first physical mesh model; and
rendering the soft-body object by using the transformed first graphic mesh model.

16. The computer readable media according to claim 15, wherein the determining relative location information between the first rendering vertex and the mapping face comprises:
projecting the first rendering vertex to the mapping face, and determining a projection point of the first rendering vertex on the mapping face;
determining first relative location information between the projection point and the mapping face;
determining second relative location information between the projection point and the first rendering vertex; and
obtaining the relative location information between the first rendering vertex and the mapping face based on the first relative location information and the second relative location information.

17. The computer readable media according to claim 16, wherein the determining first relative location information between the projection point and the mapping face comprises:
determining the first relative location information between the projection point and the mapping face by using coordinates of each physical vertex on the mapping face and coordinates of the projection point,
the first relative location information between the projection point and the mapping face being configured for establishing a linear relationship between the coordinates of each physical vertex on the mapping face and the coordinates of the projection point.

18. A system, comprising:
a processor; and
memory storing computer readable instructions that, when executed by the processor, configure the system to perform
obtaining a first physical mesh model and a first graphic mesh model of a soft-body object in a preset first form, wherein a level of precision of the first physical mesh model is less than a level of precision of the first graphic mesh model;
identifying a rendering vertex in a first-type mesh region of the first graphic mesh model as a first rendering vertex;
determining a mapping face corresponding to the first rendering vertex from faces of the first physical mesh model;
determining relative location information between the first rendering vertex and the mapping face;
identifying a rendering vertex in a second-type mesh region of the first graphic mesh model as a second rendering vertex;
determining a mapping physical vertex corresponding to the second rendering vertex from physical vertexes in the first physical mesh model;
determining relative location information between the second rendering vertex and the corresponding mapping physical vertex, wherein a complexity of the second-type mesh region is higher than a complexity of the first-type mesh region;
generating, based on each piece of relative location information, model mapping information corresponding to the soft-body object;
transforming, when rendering the soft-body object, the first graphic mesh model based on the model mapping information and transformation of the first physical mesh model; and
rendering the soft-body object by using the transformed first graphic mesh model.

19. The system of claim 18, wherein the determining relative location information between the first rendering vertex and the mapping face comprises:
projecting the first rendering vertex to the mapping face, and determining a projection point of the first rendering vertex on the mapping face;
determining first relative location information between the projection point and the mapping face;
determining second relative location information between the projection point and the first rendering vertex; and
obtaining the relative location information between the first rendering vertex and the mapping face based on the first relative location information and the second relative location information.

20. The system of claim 19, wherein the determining first relative location information between the projection point and the mapping face comprises:
determining the first relative location information between the projection point and the mapping face by using coordinates of each physical vertex on the mapping face and coordinates of the projection point,
the first relative location information between the projection point and the mapping face being configured for establishing a linear relationship between the coordinates of each physical vertex on the mapping face and the coordinates of the projection point.
